(19) United States
(12) Patent Application Publication
(10) Pub. No.: US 2025/0300360 A1
(43) Pub. Date: Sep. 25, 2025

(54) RECONFIGURABLE MEMBRANE SMART ANTENNAS AND TRANSMISSION LINES

(71) Applicant: UNM RAINFOREST INNOVATIONS, Albuquerque, NM (US)

(72) Inventors: Christos CHRISTODOULOU, Albuquerque, NM (US); Ganesh BALAKRISHNAN, Albuquerque, NM (US); Emma J. RENTERIA, Albuquerque, NM (US); Sudharman K. JAYAWEERA, Albuquerque, NM (US); Francesca CAVALLO, Albuquerque, NM (US)

(21) Appl. No.: 19/085,336

(22) Filed: Mar. 20, 2025

Related U.S. Application Data
(60) Provisional application No. 63/567,998, filed on Mar. 21, 2024.

(51) Int. Cl. H01Q 15/00; H01B 3/10; H01Q 15/14

(52) U.S. Cl. CPC H01Q 15/0026; H01Q 15/002; H01Q 15/147; H01B 3/10

(57) ABSTRACT

A multi-functional, lightweight, and deployable material that integrates a front-end photoconductive membrane with a flexible array of light sources such as vertical-cavity surface-emitting lasers (VCSELs) and light-emitting diodes (LEDs). The membrane is unstructured or free from any geometrical pattern fabricated using top-down processing techniques. A periodic array of conductive or dielectric elements is created within the semiconductor sheet by optical control of the carrier concentration via illumination by the integrated light sources. When the membrane becomes conductive, its capability of transferring, reflecting, and generating radio-frequency power increases.

### CROSS REFERENCE TO RELATED APPLICATIONS

This patent application claims priority to U.S. Provisional Application No. 63/567,998, filed on Mar. 21, 2024, which is incorporated by reference herein in its entirety.

### GOVERNMENT FUNDING

This invention was made with government support under BC2019001/FA9453-19-C-0596 awarded by AFRL. The government has certain rights in the invention.

### TECHNICAL FIELD

The present teachings relate generally to reconfigurable antennas and transmission lines.

### BACKGROUND

The reliable operation of deployable reflector antennas in outer space is challenging due to harsh environments. In addition, reflector antennas need to be steered and have limited multi-beam capability or frequency agility. These limitations stress the need for multiple antennas, which in turn increase operational costs and complexity of the platform. Furthermore, the operation of phased arrays requires the use of complex feeding techniques with very high loads in electronics and power consumption.

Types of reconfigurable antennas that are currently available have, for example, photoconductive switches, optical pumps whose profiles are structured by a spatial light modulator, embedded photoconductive silicon bowtie antennas, optically-activated arrays utilizing photonic integrated circuits (PICS), photoconductive semiconductor fiber antennas, or dynamically reconfigurable feed networks for multi-element planar array antennas.

What is needed is a system that can operate at various frequencies, various radiation patterns, and various polarizations without the need for multiple antennas and can be activated and de-activated on demand with fast switching speeds. What is further needed is a reconfigurable antenna that makes use of autonomous activation with machine learning algorithms enabling self-adaption under various RF threats and environmental conditions. What is still further needed is a reconfigurable antenna that is undetectable by search beams when not activated and includes a design that is more compact than currently available reconfigurable antennas.

### SUMMARY

The device of the present disclosure is a multi-functional, lightweight, and deployable material that integrates a front-end photoconductive membrane with a flexible array of light sources to form a multilayered structure. The light sources can include but are not limited to vertical-cavity surface-emitting lasers (VCSELs) and light-emitting diodes (LEDs). VCSELs are semiconductor laser diodes with laser beam emission from the top surface of the device. The membrane and the light emitters are made of single-crystalline semiconductors. The membrane is unstructured or free from any geometrical pattern fabricated using top-down processing techniques. A periodic array of conductive or dielectric elements (virtual pixels) is created within the semiconductor sheet by optical control of the carrier concentration via illumination by the integrated light sources. In some configurations, VCSELs and LEDs have a thickness of a few micrometers, and they are tightly packed to create a continuous path for surface current on the multilayered structure when activated. When the multilayered structure becomes conductive, its capability of transferring, reflecting, and generating radio-frequency power increases. Transmission lines and radiating or reflecting antennas can be created on the multilayered structure by activating a selected configuration of the underlying light sources.

Spatially controlling the multilayered structure conductivity via a passive matrix-addressing scheme reduces the complexity of the antennas or transmission lines while enabling reconfiguration. Furthermore, membranes materials are ultra-compliant and realizable on a flexible substrate, making them packable with high efficiency to fit in nano-satellites and deployed in space. Reconfigurable membrane materials are also conformable to non-planar probes and integrable into extravehicular activity suits.

Embodiments of the reconfigurable antenna or transmission lines, in accordance with the present disclosure, are constructed of a mechanically compliant, lightweight, and reconfigurable material that operates at multiple frequencies and polarizations. Reconfigurable antennas and transmission lines based on the present disclosure are software-controlled using, for example, but not limited to, a Field Programmable Gate Array (FPGA) with embedded machine and deep learning algorithms. An intelligent system learns from the environment and adapts to changes in the RF spectrum availability and the threats within its surroundings.

Reconfigurable and foldable materials based on single-crystalline semiconductors, in conjunction with machine learning control, display various modes of operation while eliminating the need for multiple antennas in small satellites and other platforms. Membranes are used as reflective surfaces for reconfigurable reflect arrays or reconfigurable active and modular antennas. The membranes enable the use of technical solutions for reconfigurable data or power lines on any circuit that can be dynamically rewired in space.

The multilayered structure of the present disclosure can be used for personal electronic devices, radar and satellite communication systems, and military surveillance and reconnaissance platforms. The autonomous activation of the material can be used in autonomous vehicles, unmanned aerial vehicles, the Internet of Things, biomedical sensor applications, cognitive radio and cognitive radar, and first responder communications.

The features, functions, and advantages that have been discussed can be achieved independently in various implementations, or can be combined in yet other implementations, further details of which can be seen with reference to the following description.

### BRIEF DESCRIPTION OF THE DRAWINGS

The accompanying drawings, which are incorporated in and constitute a part of this specification, illustrate embodiments of the present teachings and, together with the description, serve to explain the principles of the disclosure. In the figures:

FIG. 1 (PRIOR ART) is a pictorial representation of a photoconductive layer having an illuminated conducting strip that is illuminated by a VCSEL array;

FIG. 2 is a pictorial representation of a membrane in accordance with embodiments of the present disclosure that is a pixelated optically reconfigurable antenna, reconfigurable from a dielectric state to a reflecting dipole antenna;

FIG. 3 is a photographic representation of a VCSEL array in accordance with embodiments of the present disclosure whose activation is controlled by a FPGA; and

FIG. 4 is a pictorial representation of an exploded view of a reconfigurable membrane material along with its compliant supporting substrate and encapsulating layer in accordance with embodiments of the present disclosure.

It should be noted that some details of the figures have been simplified and are drawn to facilitate understanding of the present disclosure rather than to maintain strict structural accuracy, detail, and scale.

### DETAILED DESCRIPTION

Reference will now be made in detail to systems and methods in accordance with embodiments of the present disclosure, which are illustrated in the accompanying drawings. Wherever possible, the same reference numbers will be used throughout the drawings to refer to the same, similar, or like parts.

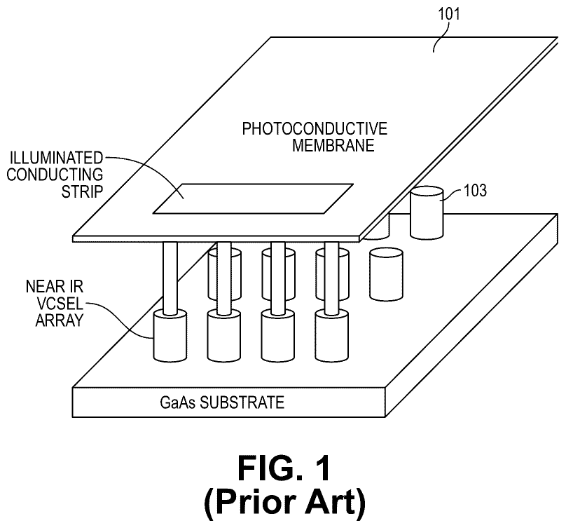

Referring now to FIG. 1 (PRIOR ART), shown is a VCSEL array illuminating a photoconductive layer. Devices in accordance with embodiments of the present disclosure use a semiconductor material 101 that is excited by VCSELs 103 to develop low-cost, adaptive, and reconfigurable radiating membranes that yield antennas for any space platform and applications such as communication, remote sensing, GPS, radar, etc.

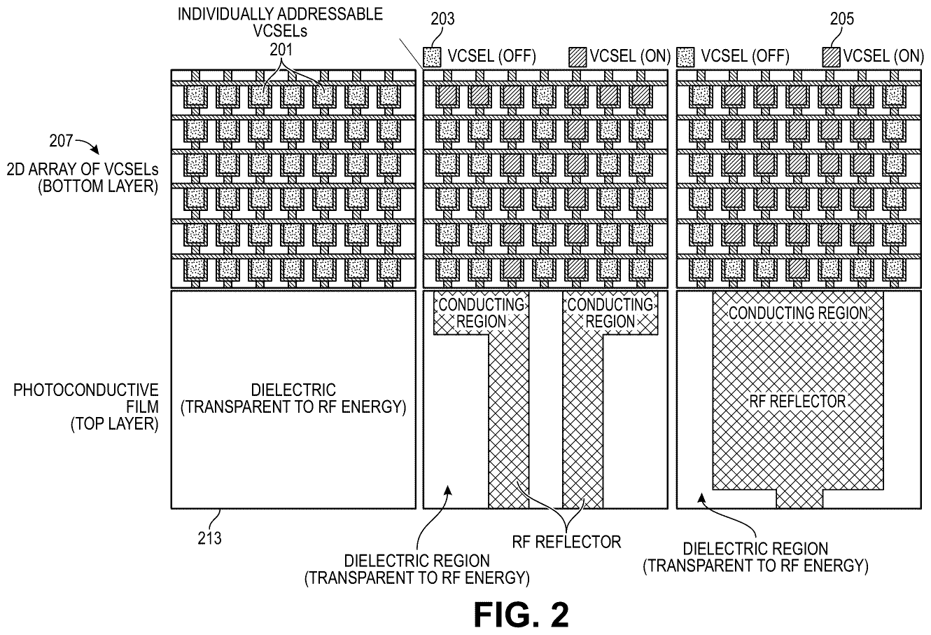

Referring now to FIG. 2, shown is a pixelated dipole antenna in accordance with the embodiments of the present disclosure. When the VCSELs 201 are not activated 203, the semiconductor membrane is not capable of radiating or reflecting RF energy. When the VCSELs 201 are activated 205, the semiconductor multilayered structure becomes conductive and can reflect or radiate the incident RF energy at a given frequency and polarization based on the size of the virtual dipole created via back-illumination. The pixelated optically reconfigurable antenna includes individually addressable VCSELs 201, in a 2D array 207, that projects radiation patterns upon the integrated photoconductive layer 213, yielding optically reconfigurable antennas on demand. In one configuration, pixelated VCSELs 201 are situated so that there is a continuous path for surface currents to flow in the photoconductive membrane.

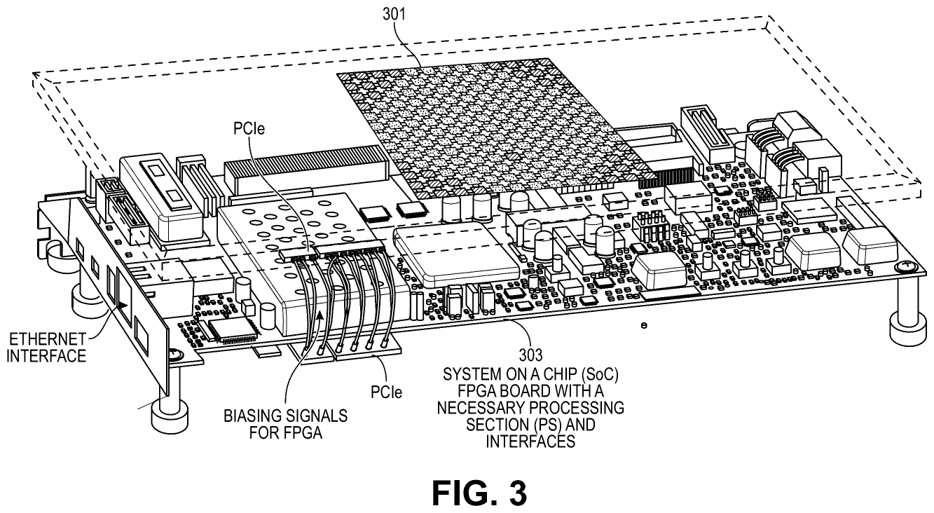

Referring now to FIG. 3, shown is a system-on-chip 303 having a VCSEL array 301 whose activation is controlled through machine-learning algorithms executing on, for example, an FPGA, a Raspberry PI, or a specialized chip designed to host machine learning (ML) or deep learning (DL) algorithms. ML and DL techniques are used to control the activation of VCSELs. When the number of reconfigurable elements is relatively small, as when the membrane is divided into segments or the number of VCSELs is small, a multilayer neural network is trained to perform the desired activation. When the number of reconfigurable VCSEL elements is large, deep learning algorithms are trained to perform the desired activations. Convolutional neural networks with several convolutional layers followed by a small number of fully-connected layers can be trained to the desired activation.

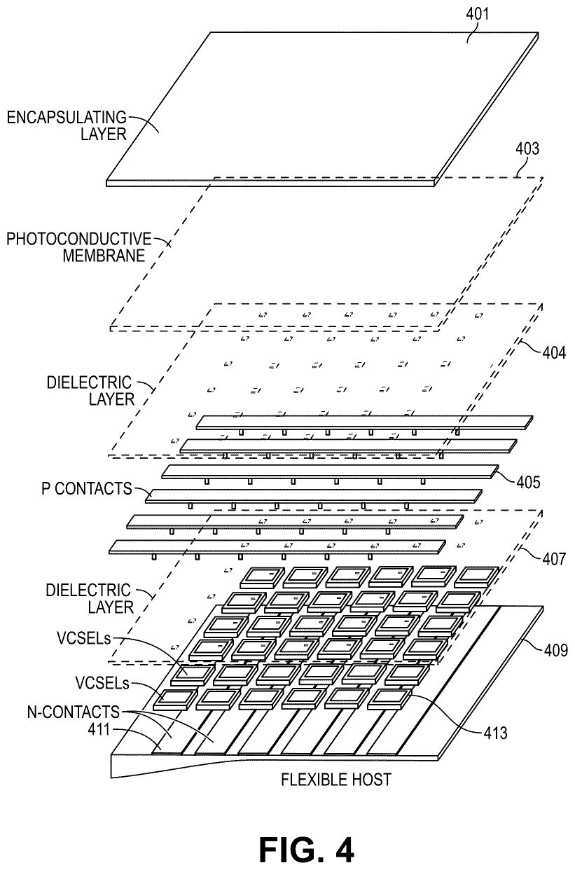

Referring now to FIG. 4, shown is an example of a membrane in accordance with embodiments of the present disclosure, including a multi-functional membrane supported by a flexible substrate 409 and encapsulated by a soft material. The membrane can be manufactured in a variety of shapes and sizes. There is virtually no upper limit on the number of VCSELs 413 that are used in the membrane, and the number of VCSELs 413 dictates the size of the membrane. In some configurations, the VCSELs 413 are spaced, for example, 0.2-3 μm apart. The encapsulating layer 401 can minimize mechanical stress in the VCSELs 413 and the photoconductive membrane 403, which can hinder crack formation when the antenna is bent. In some configurations, the substrate 409 is a flexible host capable of supporting bending up to a pre-selected radius of curvature. In some configurations, the substrate 409 is constructed of a flexible dielectric material, i.e., an insulator. The dielectric material includes, but is not limited to, polyimide (PI) materials such as KAPTON® film, polyethylene terephthalate (PET) materials such as polyester and MYLAR®, and fluoropolymer materials such as polytetrafluoroethylene (PTFE), and silicone polymers such as polydimethylsiloxane (PDMS).

Continuing to refer to FIG. 4, top contact layer 405 and bottom contact layer 411 are arranged to address the VCSELs 413 in the array individually. The contact layers 405 and 411 can be positioned at any orientation relative to the VCSELs 413, as long as they are positioned orthogonally relative to each other. The metals that the contacts are constructed of include, but are not limited to including, Au/AuZn on the p side of the VCSEL and AuGc/Ni/Ge on the n side for III-As based devices, and Au/Pt/Au/Ge on the n side Au/Ag/Pt/Ti the p-side in III-Sb-based VCSELs. In some configurations, contacts such as Au/Pt or Au/Ti are used. In some configurations, transparent conductive oxides are used.

Continuing to refer to FIG. 4, two dielectric layers are included in the membrane—a first dielectric layer 404 between the photoconductive membrane 403 and the p-contacts 405, and a second dielectric layer 407 between the p-contacts 405 and the VCSEL array 413. The function of the two dielectric layers is to electrically insulate structures in contact with them. In some configurations, the dielectric layers 404/407 are constructed of a material that provides an inorganic dielectric barrier, such as, for example, but not limited to, aluminum oxide. In some configurations, the encapsulating layer 401 is constructed of a soft material such as, for example, but not limited to, PDMS or polyimide. In some configurations, the thickness of the encapsulating layer 401 is in the range of approximately hundreds of micrometers to 2 mm. In some configurations, the photoconductive membrane 403 is constructed of, for example, Ge, gallium arsenide (GaAs), or Si, and has a thickness in the range of approximately 200 nm to 2 μm. In some configurations, the photoconductive membrane 403 is constructed of, for example, III-arsenides, III-antimonides, III-N, or III-posphides compound semiconductors and has a thickness in the range of approximately 200 nm to 2 μm.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

1. A multilayered structure comprising:
an encapsulating layer;
a photoconductive membrane;
a first dielectric layer;
a first set of contacts;
a second dielectric layer, wherein the photoconductive membrane and the first set of contacts are positioned between the encapsulating layer and the first dielectric layer, forming a stack;
a flexible host;
a VCSEL array, wherein the second dielectric layer is positioned between the first set of contacts and the VCSEL array; and
a second set of contacts positioned orthogonally to the first set of contacts, wherein the VCSEL array and the second set of contacts are positioned between the stack and the flexible host.

2. The multilayered structure as in claim 1 wherein the VCSEL array comprises:
space between VCSELs in the VCSEL array in a range of approximately 1-3 μm.

3. The multilayered structure as in claim 1 wherein the flexible host is configured to bend.

4. The multilayered structure as in claim 1 wherein the flexible host comprises:
a flexible dielectric material.

5. The multilayered structure as in claim 1 wherein the encapsulating layer comprises:
polydimethylsiloxane or polyimide.

6. The multilayered structure as in claim 1, wherein the encapsulating layer comprises:
a thickness in a range of approximately hundreds of micrometers to 2 mm.

7. The multilayered structure as in claim 1 wherein the photoconductive membrane comprises:
gallium arsenide, Si, or Ge.

8. The multilayered structure as in claim 1 wherein the photoconductive membrane comprises:
a thickness in a range of approximately 200 nm to 2 μm.

9. An antenna comprising:
a multilayered structure configured to reflect or radiate incident RF energy at a pre-selected frequency and a pre-selected polarization; and
a processor configured to activate the multilayered structure to reflect or radiate the incident RF energy at the pre-selected frequency and the pre-selected polarization.

10. The antenna as in claim 9 wherein the multilayered structure comprises:
a VCSEL array.

11. The antenna as in claim 10 wherein the processor executes operations that comprise:
machine learning instructions configured to control activation of VCSELs in the VCSEL array.

12. The antenna as in claim 10 wherein the processor executes operations that comprise:
machine learning instructions configured to learn from an environment of the antenna and adapt to changes in an RF spectrum availability and threats within the environment.

13. The antenna as in claim 9 wherein the multilayered structure comprises:
a flexible host configured to bend.

14. The antenna as in claim 13 wherein the flexible host comprises:
a flexible dielectric material.

15. The antenna as in claim 14 wherein the flexible dielectric material comprises:
Al₂O₃.

16. The antenna as in claim 14 wherein the flexible dielectric material comprises:
Si₃N₄.

17. The antenna as in claim 9 wherein the multilayered structure comprises:
an encapsulating layer comprised of polydymethilsiloxane or polyimide.

18. The antenna as in claim 17 wherein the encapsulating layer comprises:
a thickness in a range of approximately hundreds of micrometers to 10 mm.

19. The antenna as in claim 9 wherein the multilayered structure comprises:
a photoconductive membrane comprised of III-arsenides, III-antimonides, or III-posphides compound semiconductors.

20. The antenna as in claim 9 wherein the processor comprises:
a FPGA.
